(19) United States
(12) Patent Application Publication
(10) Pub. No.: US 2025/0296624 A1
(43) Pub. Date: Sep. 25, 2025

(54) VEHICLE CONTROLLER AND CONTROL METHOD

(71) Applicant: JAGUAR LAND ROVER LIMITED, Warwickshire (GB)

(72) Inventors: Bhavika SONI, Whitley, Coventry, Warwickshire (GB); Samuel TYRRELL, Whitley, Coventry, Warwickshire (GB); William WARD, Whitley, Coventry, Warwickshire (GB)

(21) Appl. No.: 18/863,685

(22) PCT Filed: May 5, 2023
(86) PCT No.: PCT/EP2023/062000

§ 371 Date: Nov. 7, 2024

(30) Foreign Application Priority Data
May 9, 2022 (GB) 2206755.7

(51) Int. Cl. B62D 7/15; B62D 5/04

(52) U.S. Cl. CPC B62D 7/159; B62D 5/0481

(57) ABSTRACT

Aspects of the present invention relate to a control system for controlling an actuator of a rear wheel steering system of a vehicle. The control system is configured to receive first and second input signals indicative of vehicle speed and power mode of a power unit of the vehicle. The control system determines the speed of the vehicle and if the power mode changes. If the vehicle speed is greater than zero and the power mode changes from on to off, the control system outputs an actuator control signal comprising an actuator displacement position request equal to zero. Aspects of the present invention also relate to a method, a system, a vehicle, and computer software and hardware for controlling a rear wheel steering system.

### TECHNICAL FIELD

The present disclosure relates to a vehicle controller and control method and particularly, but not exclusively, to a controller and a method for controlling a rear wheel steering system of a vehicle. Aspects of the invention relate to a control system, to a system comprising the control system, to a method, to a vehicle comprising the control system and/or system, to computer software arranged to perform the method, and to a non-transitory computer-readable storage medium storing instructions to carry out the method.

### BACKGROUND

It is known to provide road going vehicles with a front wheel steering system which typically comprises a driver operated steering wheel connected by a pinion gear to a steering rack which controls the angular position of the front road wheels of the vehicle, thereby controlling the direction in which the vehicle steers. The angular position of the front road wheels may be referred to as the ‘front road wheel steering angle’ which is the angle between each front road wheel and a straight-ahead position, at which the road wheel is aligned with the vehicle.

Recently, rear wheel steering (which is used in combination with front wheel steering) has become popular as it can be used to provide improved low speed manoeuvrability and high speed vehicle stability. Rear wheel steering systems commonly use a drive-by-wire system in which steering inputs made by the driver via the steering wheel are converted to electronic signals which are relayed, via a control system, to a motor driven actuator which controls the angular position of the rear road wheels of the vehicle, thereby providing rear wheel steering functionality. The angular position of the rear road wheels may be referred to as the ‘rear road wheel steering angle’ which is the angle between each rear road wheel and a straight-ahead position, at which the road wheel is aligned with the vehicle.

The rear road wheel steering angles are typically less than the front road wheel steering angles and it is the combination of the front and rear road wheel steering angles that determines the direction in which the vehicle steers. Front and rear wheel steering systems are typically configured so that the road wheel steering angles are not the same on each side of the vehicle to avoid scrub on the faster or slower rotating wheel.

It is sometimes necessary to restart the power unit of a vehicle when the vehicle is moving. For vehicles equipped with rear wheel steering, it is important that the rear wheel steering system remains under suitable control during the power unit restart cycle to avoid unexpected steering feel, and to ensure full availability of the rear wheel steering functionality once the power unit resumes operation.

### SUMMARY OF THE INVENTION

It is an aim of the present invention to address one or more of the disadvantages associated with the prior art.

Aspects and embodiments of the invention provide a control system, a system, a method, a vehicle, computer software and a and non-transitory, computer-readable storage medium as claimed in the appended claims.

According to an aspect of the present invention there is provided a control system for controlling an actuator of a rear wheel steering system of a vehicle, the control system comprising one or more controllers, the control system configured to: receive a first input signal indicative of vehicle speed, and determine a vehicle speed in dependence on the first input signal; receive a second input signal indicative of the power mode of a power unit of the vehicle, wherein the second input signal has a first state corresponding to a power mode ON, and a second state corresponding to a power mode OFF; determine, in dependence on the second input signal, if the power mode changes from ON to OFF; and output an actuator control signal to control the actuator of the rear wheel steering system, the actuator control signal comprising an actuator displacement position request equal to zero if the vehicle speed is greater than zero and the power mode changes from ON to OFF.

The present invention is advantageous as control of the rear wheel steering system is maintained even if the vehicle's power unit is powered-off and/or restarted whilst the vehicle is moving. Suitable steering feel is maintained by controlling the rear wheel steering system to move to the zero, or home, displacement position when the vehicle's ignition is turned off on the move.

In an embodiment, the one or more controllers collectively comprise: at least one electronic processor having an electrical input for receiving the first and/or second input signals; and at least one memory device electrically coupled to the at least one electronic processor and having instructions stored therein; and wherein the at least one electronic processor is configured to access the at least one memory device and execute the instructions thereon so as to: determine the vehicle speed; determine the power mode; and output the actuator control signal in dependence on the determined vehicle speed and power mode.

Optionally, the control system may be configured to: determine if the vehicle speed remains greater than zero after the power mode has changed from ON to OFF; determine if the power mode remains OFF; and output an actuator control signal comprising an actuator displacement position request equal to zero if the vehicle speed remains greater than zero, and the power mode remains OFF. The control system therefore advantageously continues to control the displacement of the rear wheel steering system even if the power unit remains off for an extended period of time in which other vehicle control systems may shut down.

The control system may optionally be configured to: determine if the vehicle speed is zero after the power mode has changed from ON to OFF; determine if the power mode is OFF; and cease output of actuator control signals if the vehicle speed is zero, and the power mode is OFF. Power is thereby conserved when the power unit is off and the speed is zero.

The control system may be configured to: receive a third input signal indicative of a steering system input, and determine an actuator displacement position set point in dependence on the third input signal; determine if the vehicle speed is greater than zero; determine if the power mode changes from OFF to ON; and output an actuator control signal comprising an actuator displacement position request equal to the actuator displacement position set point if the vehicle speed is greater than zero and the power mode changes from OFF to ON. This is advantageous as the displacement position of the rear wheel steering system can be moved to the driver requested displacement position as soon as the power unit is turned back on.

In an embodiment, the control system may be configured to: receive a fourth input signal indicative of an actual actuator displacement; determine the magnitude of the difference between the actuator displacement position set point and the actual actuator displacement; use the determined magnitude of the difference between the actuator displacement position set point and the actual actuator displacement to determine a rate of change of actuator displacement; and output an actuator control signal comprising a request to operate the actuator at the determined rate of change. This is advantageous as the displacement position of the rear wheel steering system can be blended to the driver requested displacement position at a suitable rate so that the driver does not notice the change and experiences no unexpected steering feel.

Optionally the control system may be configured to: use the determined vehicle speed to determine a rate of change of actuator displacement; and output an actuator control signal comprising a request to operate the actuator at the determined rate of change. As above, this is advantageous as the displacement position of the rear wheel steering system can be blended to the driver requested displacement position at a suitable rate so that the driver does not notice the change and experiences no unexpected steering feel. Optionally both the difference between the actuator displacement position set point and the actual actuator displacement and the vehicle speed may be used to determine the rate of change of actuator displacement.

According to another aspect of the invention, there is provided a system, comprising: an actuator having a moveable actuator element, wherein displacement of the actuator element from a zero position determines a steering position of a rear wheel steering system; and the control system of any preceding claim, including at least a first controller, wherein the at least a first controller is arranged to output an actuator control signal for causing movement of the actuator element, wherein the actuator is configured to receive the actuator control signal and move the actuator element in dependence on the actuator control signal.

According to a further aspect of the invention, there is provided a method for controlling an actuator of a rear wheel steering system of a vehicle, the method comprising: receiving a signal indicative of vehicle speed and determining a vehicle speed in dependence on the signal indicative of vehicle speed; receiving a second input signal indicative of the power mode of a power unit of the vehicle, wherein the second input signal has a first state corresponding to a power mode ON, and a second state corresponding to a power mode OFF; determining, in dependence on the second input signal, if the power mode changes from ON to OFF; outputting an actuator control signal to control the actuator of the rear wheel steering system, the actuator control signal comprising an actuator displacement position request equal to zero if the vehicle speed is greater than zero and the power mode changes from ON to OFF.

Optionally the method comprises: determining if the vehicle speed remains greater than zero after the power mode has changed from ON to OFF; determining if the power mode remains OFF; and outputting an actuator control signal comprising an actuator displacement position request equal to zero if the vehicle speed remains greater than zero, and the power mode remains OFF.

The method may optionally comprise: determining if the vehicle speed is zero after the power mode has changed from ON to OFF; determining if the power mode is OFF; and ceasing output of actuator control signals if the vehicle speed is zero, and the power mode is OFF.

The method may comprise: receiving a third input signal indicative of a steering system input, and determining an actuator displacement position set point in dependence on the third input signal; determining if the vehicle speed is greater than zero; determining if the power mode changes from OFF to ON; outputting an actuator control signal comprising an actuator displacement position request equal to the actuator displacement position set point if the vehicle speed is greater than zero and the power mode changes from OFF to ON.

In an embodiment the method may comprise: receiving a fourth input signal indicative of an actual actuator displacement; determining the magnitude of the difference between the actuator displacement position set point and the actual actuator displacement; using the determined magnitude of the difference between the actuator displacement position set point and the actual actuator displacement to determine a rate of change of actuator displacement; and outputting an actuator control signal comprising a request to operate the actuator at the determined rate of change.

Optionally the method comprises: using the determined vehicle speed to determine a rate of change of actuator displacement; and outputting an actuator control signal comprising a request to operate the actuator at the determined rate of change.

According to a still further aspect of the invention, there is provided a vehicle comprising the control system, or the system described above.

According to a yet another aspect of the invention, there is provided computer software that, when executed, is arranged to perform a method described above.

According to a yet further aspect of the invention, there is provided a non-transitory, computer-readable storage medium storing instructions thereon that, when executed by one or more electronic processors, causes the one or more electronic processors to carry out the method described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic illustration of a vehicle in accordance with an embodiment of the invention;

FIG. 2 shows a block diagram of a control system such as may be adapted in accordance with an embodiment of the invention;

FIG. 3 shows a flow diagram illustrating an example logic flow in accordance with an embodiment of the invention;

FIG. 4 shows a flow diagram illustrating another example logic flow in accordance with an embodiment of the invention; and

FIG. 5 shows a simplified example of a control system such as may be adapted in accordance with an embodiment of the invention.

### DETAILED DESCRIPTION

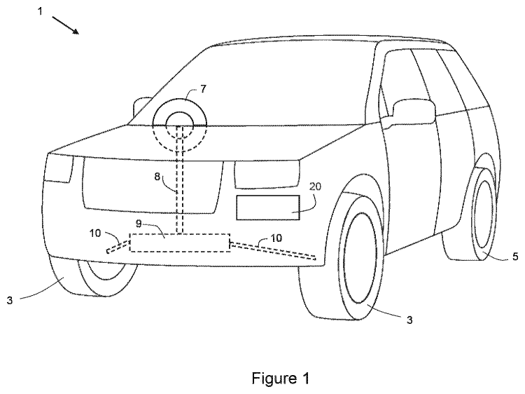

A vehicle 1 in accordance with an embodiment of the present invention is described herein with reference to the accompanying FIG. 1.

The vehicle 1 comprises a pair of front road wheels 3 and a pair of rear road wheels 5, each of which are supported for rotation by a sub-structure (not shown) of the vehicle 1.

The direction in which the front road wheels 3 steer is controlled by movement of a driver operated steering wheel 7 which is connected to a steering rack 9 via a steering column 8.

The steering rack 9 is connected by tie rods 10 to each of the front steering knuckles (not shown). Rotation of the steering wheel 7 by a driver causes linear movement of the steering rack 9 which is transmitted to the front steering knuckles by the tie rods 10 to cause the front road wheels steering angle to vary in response to movement of the steering wheel 7.

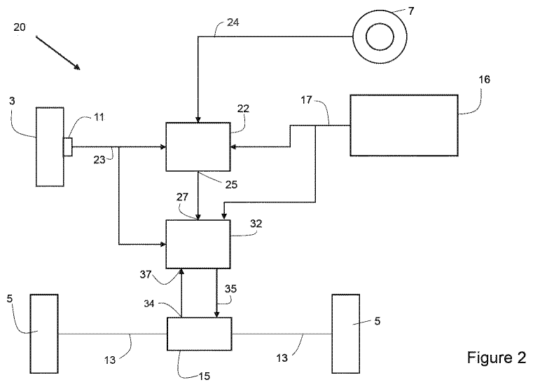

The direction in which the rear road wheels 5 steer is adjusted by an actuator 15 (see FIG. 2). The actuator 15 is controlled by a rear wheel steering control system 20 described below in detail with reference to FIGS. 2 to 5. The actuator 15 comprises a moveable actuator element (not shown) which is driven by an electric motor (not shown). The actuator element is connected via mechanical linkages 13 to rear steering knuckles (not shown). Displacement of the actuator element from a home, or zero, position is transmitted to the rear steering knuckles by the mechanical linkages 13 to cause the rear road wheel steering angle to vary in response to movement of the actuator element. In an alternative embodiment (not shown) the rear road wheel steering angle may be controlled by a separate actuator, or the actuator 15 may comprise more than one actuator element, one for each rear road wheel 5.

Referring to FIG. 2, the rear wheel steering control system 20 comprises a first controller 22 and a second controller 32. The first controller 22 is configured to receive a speed input signal 23 indicative of vehicle speed. The speed input signal 23 may comprise a measurement signal obtained by a wheel rotation speed sensor 11, in which case the controller 22 is configured to determine the vehicle speed from the measurement signal received from the wheel rotation speed sensor 11. In an alternative embodiment, the measurement signal from the wheel rotation speed sensor 11 may be pre-processed such that the speed input signal 23 comprises the vehicle speed as determined by the pre-processor. In each case, the first controller 22 determines the vehicle speed in dependence on the speed input signal 23.

The first controller 22 is also configured to receive a steering input signal 24 indicative of the angular position of the steering wheel 7. The first controller 22 is configured to determine an actuator displacement position set point in dependence on the steering input signal 24 and the speed input signal 23. The first controller 22 is configured to output a signal 25 indicative of the actuator displacement position set point and the second controller 32 is configured to receive the output signal 25 from the first controller 22 as an input signal 27 indicative of the actuator displacement position set point.

The first 22 and second 32 controllers 22 are configured to receive a power mode input signal 17 indicative of the power mode of a power unit 16 of the vehicle 1. The power mode input signal 17 has a first state corresponding to a power unit power mode ON, and a second state corresponding to a power unit power mode OFF. The power mode input signal 17 is directly linked to the operative condition of the vehicle's power unit such that a power mode input signal 17 equal to ON corresponds to the power unit being on and operative to provide power to drive the vehicle, and a power mode input signal 17 equal to OFF corresponds to the power unit being off. The first 22 and second 32 controllers are configured to determine, in dependence on the power mode input signal 17, if the power unit power mode is ON or OFF, or if it has changed from ON to OFF, or from OFF to ON.

It will be understood that the power mode input signal 17 can be supplied to the steering control system 20 from the power unit itself, from a cockpit mounted, driver controlled, switch, from a vehicle control unit (not shown), or from any other suitable vehicle system. Similarly, the speed input signal 23 and the steering input signal 24 may be supplied to the steering control system 20 from a vehicle control unit (not shown), or from any other suitable vehicle system.

The second controller 32 is also configured to receive the speed input signal 23 indicative of vehicle speed. As described above with respect to the first controller 22, the speed input signal 23 may comprise a measurement signal obtained by the wheel rotation speed sensor 11, or the measurement signal obtained by the wheel rotation speed sensor 11 may be pre-processed such that the speed input signal 23 comprises the vehicle speed as determined by the pre-processor. In each case, the second controller 32 determines the vehicle speed in dependence on the speed input signal 23.

In an alternative embodiment (not shown), the first controller 22 may be configured to output the vehicle speed as an output signal indicative of vehicle speed, and the control system 20 may be configured so that the output signal indicative of vehicle speed from the first controller 22 is received as an input indicative of vehicle speed by the second controller 32.

The actuator 15 comprises a displacement sensor (not shown) configured to measure the actual displacement of the actuator element from the home, or zero, position. The displacement sensor is configured to output a signal 34 indicative of the actual actuator displacement. The second controller 32 is configured to receive the output signal 34 from the displacement sensor as an input signal 37 indicative of the actual actuator displacement.

The second controller 32 is configured to determine, in dependence on the input signal 27 indicative of the actuator displacement position set point and the input signal 37 indicative of the actual actuator displacement, the magnitude of any difference between the actuator displacement position set point and the actual actuator displacement.

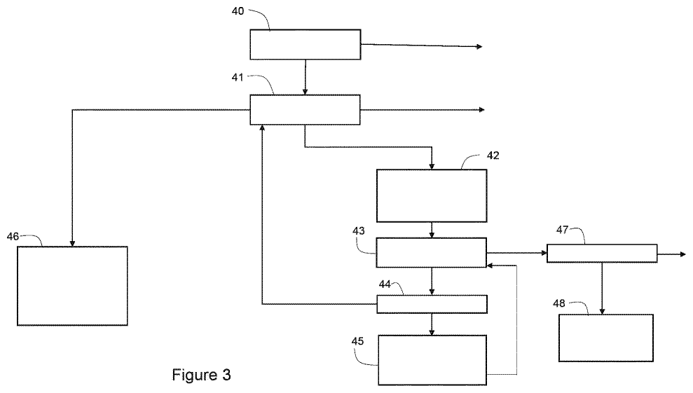

The second controller 32 is configured to output an actuator control signal 35 to control displacement of the actuator element from its home, or zero position. The actuator control signal 35 comprises an actuator displacement position request which is determined by the control system 20 in dependence on the control system inputs described above. FIG. 3 shows a flow diagram illustrating an example logic flow implemented by the control system 20.

Referring to FIG. 3, in a first step 40 the first controller 22 determines if the vehicle speed is greater than zero. If the vehicle speed is not greater than zero the control system 20 implements control of the actuator 15 via a control methodology which is not the subject of this application.

If the vehicle speed is greater than zero the logic flow moves to step 41 where the first controller 22 determines if the power unit power mode has changed to a different state, and if so in which sense. If the power unit power mode has not changed, the control system 20 implements control of the actuator 15 via a control methodology which is not the subject of this application.

If the power unit power mode has changed from ON to OFF, the logic flow moves to step 42 in which the second controller 32 outputs an actuator control signal 35 comprising an actuator displacement position request equal to zero. The actuator 15 is thereby instructed to return the actuator element to its home, or zero, position, or to maintain the actuator element at its home, or zero, position if it is already there.

The logic flow then moves to step 43 where it is determined by the first 22 and/or second 32 controller if the vehicle speed remains above zero. If the speed remains above zero, the logic flow moves on to step 44 where it is determined by the first 22 and/or second 32 controller if the power unit power mode remains OFF. If the power mode remains OFF, the logic flow moves to step 45 in which the second controller 32 outputs an actuator control signal 35 comprising an actuator displacement position request equal to zero so that the actuator element is maintained at its home, or zero, position.

If the vehicle speed in step 43 is not greater than zero, the logic flow moves to step 47 where it is determined if the power unit power mode remains OFF. If the power mode remains OFF in step 47 the logic flow moves to step 48 where the control system 20 ceases to output control signals to the actuator 15 and the actuator 15 shuts down. If the power mode is not OFF in step 47 the control system 20 implements control of the actuator 15 via a control methodology which is not the subject of this application.

Returning now to step 41 of the logic flow, if (after it has been determined in step 40 that the vehicle speed is greater than zero) the power unit power mode changes from OFF to ON, the logic flow moves to step 46 in which the second controller 32 outputs an actuator control signal 35 comprising an actuator displacement position request equal to the actuator displacement position set point. This circumstance arises after step 44 if it is determined in step 44 that the power unit is no longer OFF. This is illustrated in the logic flow of FIG. 3 by the connector arrow which connects step 44 to step 41 in the event that the power unit is no longer OFF in step 44.

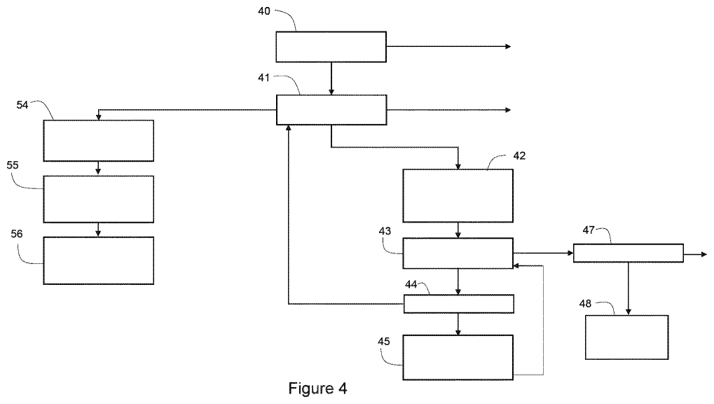

FIG. 4 illustrates another example logic flow which may be implemented by the control system 20. The logic flow of FIG. 4 is the same in all respects to the logic flow of FIG. 3 except in that step 46 of FIG. 3 is replaced with steps 54 to 56.

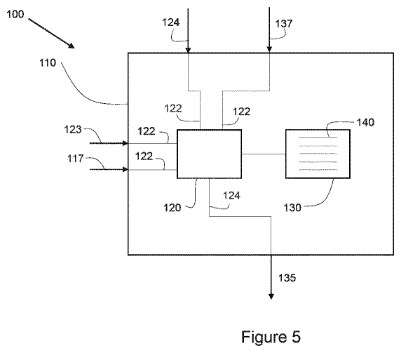

Starting at step 41 of FIG. 4, if (after it has been determined in step 40 that the vehicle speed is greater than zero) the power unit power mode changes from OFF to ON, the logic flow moves to step 54 in which the second controller 32 determines the difference in magnitude between actuator displacement position set point and actual actuator displacement. The logic flow then moves to step 55 in which the second controller 32 determines a suitable rate of change of the actuator element in dependence on the magnitude of the difference between actuator displacement position set point and actual actuator displacement and/or the vehicle speed. A calibration table stored in a memory 130 (See FIG. 5) of the control system 20 may be used to determine the rate of change of the actuator element.

Once the rate of change of the actuator element has been determined in step 55 the logic flow moves on to step 56 in which the second controller 32 outputs an actuator control signal 35 comprising an actuator displacement position request equal to the actuator displacement position set point, and a request to operate the actuator at the determined rate of change.

If only the vehicle speed is used to determine the rate of change of the actuator element in step 55, step 54 may be dispensed with.

With reference to FIG. 5, there is illustrated a simplified example of a control system 100 such as may be adapted to implement the method of FIG. 3 or FIG. 4 described above. The control system 100 comprises one or more controllers 110 and is configured to receive a first input signal 123 indicative of vehicle speed, and determine a vehicle speed in dependence on the first input signal 123; receive a second input signal 117 indicative of the power mode of a power unit of the vehicle, wherein the second input signal 117 has a first state corresponding to a power mode ON, and a second state corresponding to a power mode OFF; determine, in dependence on the second input signal 117, if the power mode changes from ON to OFF; and output an actuator control signal 135 to control the actuator 15 of the rear wheel steering system, the actuator control signal 135 comprising an actuator displacement position request equal to zero if the vehicle speed is greater than zero and the power mode changes from ON to OFF.

The control system 100 is also configured to receive a third input signal 124 indicative of a steering system input, and determine an actuator displacement position set point in dependence on the third input signal 124; determine if the power mode changes from OFF to ON; and output an actuator control signal 135 comprising an actuator displacement position request equal to the actuator displacement position set point if the vehicle speed is greater than zero and the power mode changes from OFF to ON.

The control system 100 is also configured to receive a fourth input signal 137 indicative of an actual actuator displacement; determine the magnitude of the difference between the actuator displacement position set point and the actual actuator displacement; use the determined magnitude of the difference between the actuator displacement position set point and the actual actuator displacement to determine a rate of change of actuator displacement; and output an actuator control signal comprising a request to operate the actuator at the determined rate of change.

It is to be understood that the or each controller 110 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 110 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 110 to implement the control techniques described herein (including some or all of the functionality required for the method described herein). The set of instructions could be embedded in said one or more electronic processors of the controller 110; or alternatively, the set of instructions could be provided as software to be executed in the controller 110. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 5, the or each controller 110 comprises at least one electronic processor 120 having one or more electrical input(s) 122 for receiving one or more of the first 123, second 117, third 124 and/or fourth 137 input signals, and one or more electrical output(s) 124 for outputting one or more output signals 135. The or each controller 110 further comprises at least one memory device 130 electrically coupled to the at least one electronic processor 120 and having instructions 140 stored therein. The at least one electronic processor 120 is configured to access the at least one memory device 130 and execute the instructions 140 thereon so as to determine the vehicle speed; determine the power mode; and output the actuator control signal in dependence on the determined vehicle speed and power mode.

The, or each, electronic processor 120 may comprise any suitable electronic processor (e.g., a microprocessor, a microcontroller, an ASIC, etc.) that is configured to execute electronic instructions. The, or each, electronic memory device 130 may comprise any suitable memory device and may store a variety of data, information, threshold value(s), lookup tables or other data structures, and/or instructions therein or thereon. In an embodiment, the memory device 130 has information and instructions for software, firmware, programs, algorithms, scripts, applications, etc. stored therein or thereon that may govern all or part of the methodology described herein. The processor, or each, electronic processor 120 may access the memory device 130 and execute and/or use that or those instructions and information to carry out or perform some or all of the functionality and methodology describe herein. The at least one memory device 130 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions. Example controllers 110 have been described comprising at least one electronic processor 120 configured to execute electronic instructions stored within at least one memory device 130, which when executed causes the electronic processor(s) 120 to carry out the method as hereinbefore described. However, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc. It will be appreciated that various changes and modifications can be made to the present invention without departing from the scope of the present application.

1. A control system for controlling an actuator of a rear wheel steering system of a vehicle, the control system comprising one or more controllers, the control system configured to:
receive a first input signal indicative of vehicle speed, and determine a vehicle speed in dependence on the first input signal;
receive a second input signal indicative of the power mode of a power unit of the vehicle, wherein the second input signal has a first state corresponding to a power mode ON, and a second state corresponding to a power mode OFF;
determine, in dependence on the second input signal, if the power mode changes from ON to OFF; and
output an actuator control signal to control the actuator of the rear wheel steering system, the actuator control signal comprising an actuator displacement position request equal to zero if the vehicle speed is greater than zero and the power mode changes from ON to OFF.

2. The control system of claim 1, wherein the one or more controllers collectively comprise:
at least one electronic processor having an electrical input for receiving the first and/or second input signals; and
at least one memory device electrically coupled to the at least one electronic processor and having instructions stored therein;
and wherein the at least one electronic processor is configured to access the at least one memory device and execute the instructions thereon so as to:
determine the vehicle speed;
determine the power mode; and
output the actuator control signal in dependence on the determined vehicle speed and power mode.

3. The control system of claim 1, configured to:
determine if the vehicle speed remains greater than zero after the power mode has changed from ON to OFF;
determine if the power mode remains OFF; and
output an actuator control signal comprising an actuator displacement position request equal to zero if the vehicle speed remains greater than zero, and the power mode remains OFF.

4. The control system of claim 1, configured to:
determine if the vehicle speed is zero after the power mode has changed from ON to OFF;
determine if the power mode is OFF; and
cease output of actuator control signals if the vehicle speed is zero, and the power mode is OFF.

5. The control system of claim 1, configured to:
receive a third input signal indicative of a steering system input, and determine an actuator displacement position set point in dependence on the third input signal;
determine if the vehicle speed is greater than zero;
determine if the power mode changes from OFF to ON; and
output an actuator control signal comprising an actuator displacement position request equal to the actuator displacement position set point if the vehicle speed is greater than zero and the power mode changes from OFF to ON.

6. The control system of claim 5, configured to:
receive a fourth input signal indicative of an actual actuator displacement;
determine the magnitude of the difference between the actuator displacement position set point and the actual actuator displacement;
use the determined magnitude of the difference between the actuator displacement position set point and the actual actuator displacement to determine a rate of change of actuator displacement; and
output an actuator control signal comprising a request to operate the actuator at the determined rate of change.

7. The control system of claim 5, configured to:
use the determined vehicle speed to determine a rate of change of actuator displacement; and
output an actuator control signal comprising a request to operate the actuator at the determined rate of change.

8. A system, comprising:
an actuator having a moveable actuator element, wherein displacement of the actuator element from a zero position determines a steering position of a rear wheel steering system; and
the control system of any preceeding claim, including at least a first controller, wherein the at least a first controller is arranged to output an actuator control signal for causing movement of the actuator element, wherein the actuator is configured to receive the actuator control signal and move the actuator element in dependence on the actuator control signal.

9. A method for controlling an actuator of a rear wheel steering system of a vehicle, the method comprising:
receiving a signal indicative of vehicle speed and determining a vehicle speed in dependence on the signal indicative of vehicle speed;
receiving a second input signal indicative of the power mode of a power unit of the vehicle, wherein the second input signal has a first state corresponding to a power mode ON, and a second state corresponding to a power mode OFF;
determining, in dependence on the second input signal, if the power mode changes from ON to OFF;
outputting an actuator control signal to control the actuator of the rear wheel steering system, the actuator control signal comprising an actuator displacement position request equal to zero if the vehicle speed is greater than zero and the power mode changes from ON to OFF.

10. The method of claim 9 comprising:
determining if the vehicle speed remains greater than zero after the power mode has changed from ON to OFF;
determining if the power mode remains OFF; and
outputting an actuator control signal comprising an actuator displacement position request equal to zero if the vehicle speed remains greater than zero, and the power mode remains OFF.

11. The method of claim 9, comprising:
determining if the vehicle speed is zero after the power mode has changed from ON to OFF;
determining if the power mode is OFF; and
ceasing output of actuator control signals if the vehicle speed is zero, and the power mode is OFF.

12. The method of claim 9, comprising:
receiving a third input signal indicative of a steering system input, and determining an actuator displacement position set point in dependence on the third input signal;
determining if the vehicle speed is greater than zero;
determining if the power mode changes from OFF to ON;
outputting an actuator control signal comprising an actuator displacement position request equal to the actuator displacement position set point if the vehicle speed is greater than zero and the power mode changes from OFF to ON.

13. The method of claim 12, comprising:
receiving a fourth input signal indicative of an actual actuator displacement;
determining the magnitude of the difference between the actuator displacement position set point and the actual actuator displacement;
using the determined magnitude of the difference between the actuator displacement position set point and the actual actuator displacement to determine a rate of change of actuator displacement; and
outputting an actuator control signal comprising a request to operate the actuator at the determined rate of change.

14. The method of claim 12, comprising:
using the determined vehicle speed to determine a rate of change of actuator displacement; and
outputting an actuator control signal comprising a request to operate the actuator at the determined rate of change.

15. A vehicle comprising the control system of claim 1, or the system of claim 8.

16. Computer software that, when executed, is arranged to perform a method according to claim 9.

17. A non-transitory, computer-readable storage medium storing instructions thereon that, when executed by one or more electronic processors, causes the one or more electronic processors to carry out the method of claim 9.
